(19) United States
(12) Patent Application Publication
(10) Pub. No.: US 2015/0084581 A1
(43) Pub. Date: Mar. 26, 2015

(54) CHARGING DEVICE CONFIGURED TO REDUCE POWER CONSUMPTION DURING NON-CHARGING PERIOD

(71) Applicant: HITACHI KOKI CO., LTD., Tokyo (JP)

(72) Inventors: Yasushi Nakano, Hitachinaka-shi (JP); Kazuhiko Funabashi, Hitachinaka-shi (JP)

(21) Appl. No.: 14/477,711

(22) Filed: Sep. 4, 2014

(30) Foreign Application Priority Data
Sep. 24, 2013 (JP) 2013-197022

(51) Int. Cl. H02J 7/00

(52) U.S. Cl. CPC H02J 7/0052; H02J 7/007
USPC 320/107

(57) ABSTRACT

A charging device includes a first connection portion, a charge controller, a power supply circuit and a second connection portion. A secondary battery is connectable to the first connection portion. The charge controller is configured to control selected one of a charging voltage and a charging current. The power supply circuit is configured to supply the charge controller with power. The second connection portion is connectable to external power supply. Supplying power is halted to place the charge controller in a power cutoff state during a period of time from a time when the external power supply is connected to the second connection portion to a time when the secondary battery is connected to the first connection portion and also during a period of time from a time when the secondary battery has become fully charged to a time when the secondary battery is disconnected from the first connection portion.

### CROSS REFERENCE TO RELATED APPLICATION

This application claims priority from Japanese Patent Application No. 2013-197022 filed Sep. 24, 2013. The entire content of the priority application is incorporated herein by reference.

### TECHNICAL FIELD

The present invention relates to a charging device, and particularly to a charging device suitable for charging secondary batteries used to power cordless power tools.

### BACKGROUND

Battery packs that house secondary batteries have been widely used to supply power to various types of electrical equipment. However, there are some problematic issues in charging the secondary batteries contained in the battery packs. Various resolutions to these issues have been proposed.

For example, most charging devices of today are provided with a control unit that controls the charging voltage and charging current supplied to the secondary battery in order to charge the battery safely and efficiently. Since power is supplied from an external power supply to the control unit in this type of charging device even when the charging device is not charging a secondary battery, the charging device consumes external power even when the device is not charging a battery.

Japanese patent application publication No. 2011-78246 proposes a charging device capable of resolving this issue. This charging device is configured to consume little or no power from the external power supply once the secondary battery has become fully charged.

The conventional charging device described above attempts to reduce the consumption of external power by interrupting the supply of power from the external power supply to the control unit of the charging device when the secondary battery is fully charged and uses the charged secondary battery as a source for supplying power to the control unit. However, while this method reduces power consumption from the external power supply, the charging device does not provide a complete solution to the conventional issue because power is being consumed from the secondary battery, which is the target of the charging operation.

### SUMMARY

In view of the foregoing, it is an object of the present invention to provide a charging device that reduces power consumption in both the external power supply and the secondary battery when the charging device is not charging the secondary battery.

In order to attain the above and other objects, the invention provides a charging device that may include a first connection portion, a charge controller, a power supply circuit, and a second connection portion. A secondary battery is connectable to the first connection portion. The charge controller is configured to control selected one of a charging voltage and a charging current, and apply the controlled charging voltage or the controlled charging current to the secondary battery through the first connection portion. The power supply circuit is configured to supply the charge controller with power for driving the charge controller. The second connection portion is connectable to an external power supply. For example supplying power from the power supply circuit to the charge controller may be halted to place the charge controller in a power cutoff state during a period of time from a time when the external power supply is connected to the second connection portion to a time when the secondary battery is connected to the first connection portion and also during a period of time from a time when the secondary battery has become fully charged to a time when the secondary battery is disconnected from the first connection portion.

According to another aspect, the present invention provides a charging device that may include a charge controller, and a power supply circuit. The charge controller is configured to control selected one of a charging voltage and a charging current, and apply the controlled charging voltage or the controlled charging current to a secondary battery. The power supply circuit is configured to supply the charge controller with power for driving the charge controller. For example, supplying power from the power supply circuit to the charge controller may be halted to place the charge controller in a power cutoff state except when the secondary battery is being charged.

### BRIEF DESCRIPTION OF THE DRAWINGS

The particular features and advantages of the invention as well as other objects will become apparent from the following description taken in connection with the accompanying drawings, in which:

FIG. 1 is a circuit diagram for a charging device according to one embodiment of the present invention; and

FIGS. 2A and 2B are flowcharts showing steps in a control process performed by the charging device according to the embodiment for charging a secondary battery.

### DETAILED DESCRIPTION

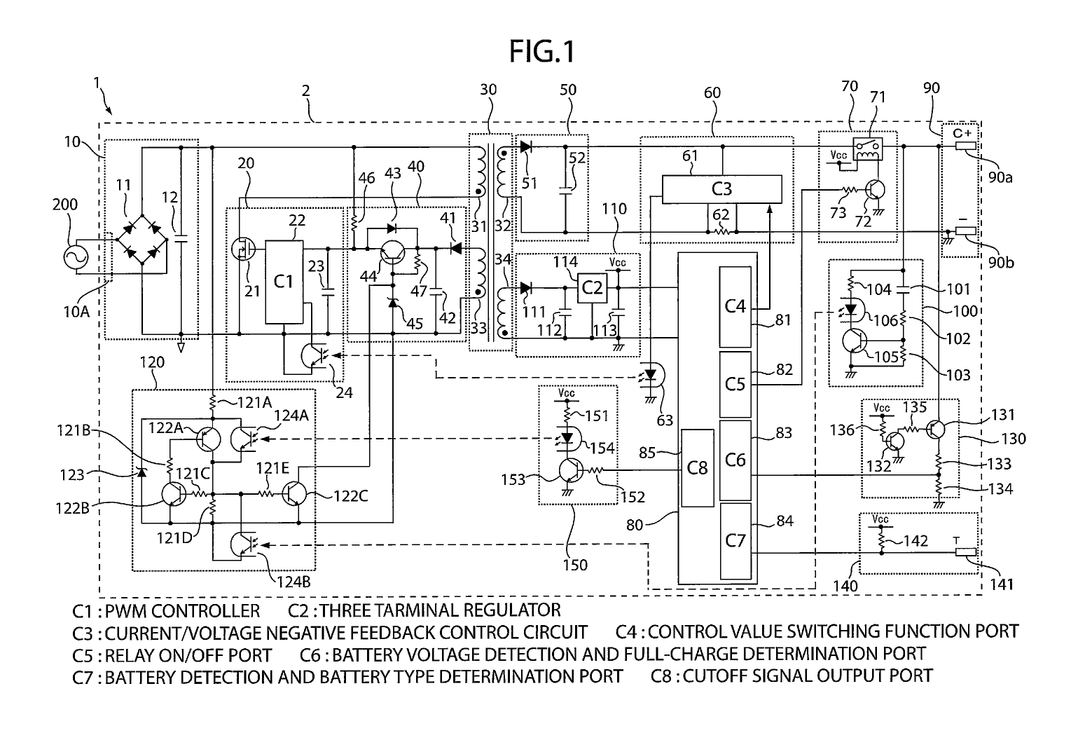

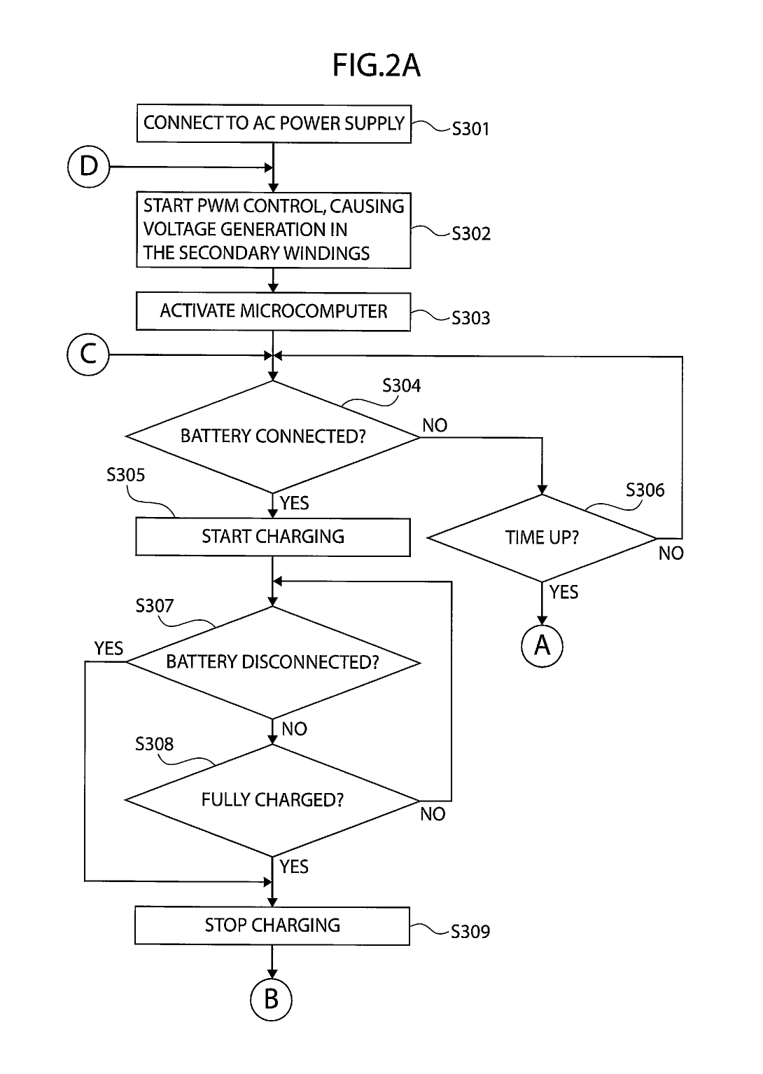

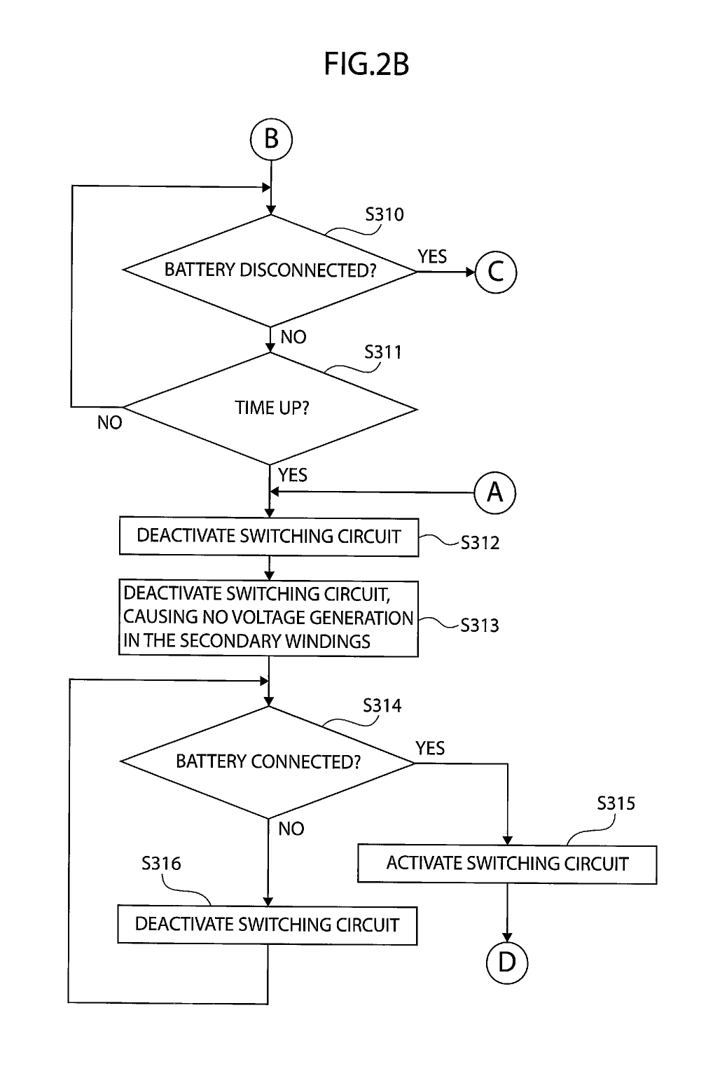

A charging device 1 according to one embodiment of the present invention will be described while referring to FIGS. 1, 2A and 2B. FIG. 1 is a circuit diagram and block diagram showing the structure of a charging circuit 2 provided in the charging device 1 according to the embodiment. The charging circuit 2 includes a first rectifying and smoothing circuit 10, a switching circuit 20, a high-frequency transformer 30, a switching power supply circuit 40, a second rectifying and smoothing circuit 50, a charging current/voltage control circuit 60, a relay circuit 70, a control unit 80, a battery connection portion 90, a release circuit 100, a constant-voltage power supply circuit 110, a cutoff holding circuit 120, a battery voltage detection circuit 130, a battery type detection circuit 140, and a signal transmission circuit 150. While the charging device 1 is connected to an AC power supply 200, the charging device 1 can charge a battery pack (not shown) housing a secondary battery that is connected to the battery connection portion 90.

The first rectifying and smoothing circuit 10 has an input portion 10A that can be connected to the AC power supply 200, and an output portion that is connected to the high-frequency transformer 30 through the switching circuit 20. The input portion 10A of the first rectifying and smoothing circuit 10 is an example of a second connection portion, and an example of an external power supply connection portion. The AC power supply 200 is an example of an external power supply. The first rectifying and smoothing circuit 10 is configured of a full-wave rectifying circuit 11 and a smoothing capacitor 12. The first rectifying and smoothing circuit 10 rectifies and smooths voltage inputted from the AC power supply 200 and outputs the resulting voltage to the high-frequency transformer 30.

The switching circuit 20 is configured of a PWM controller 22, a MOSFET 21, a capacitor 23, and a signal transmission unit 24. The PWM controller 22 is connected to the gate of the MOSFET 21 and performs what is known as pulse width modulation (PWM) control to control the output voltage to modify the drive pulse width of the MOSFET 21 based on a signal received from the signal transmission unit 24. Through this PWM control, the switching circuit 20 controls the charging voltage and charging current and produces its own driving power source.

The MOSFET 21 has a source connected to the first rectifying and smoothing circuit 10 and a drain connected to a primary winding 31 of the high-frequency transformer 30. The MOSFET 21 performs switching actions in response to a signal that the PWM controller 22 outputs to the gate of the MOSFET 21.

The capacitor 23 stabilizes the voltage of the power supply inputted into the PWM controller 22. The signal transmission unit 24 is a photocoupler or the like.

The high-frequency transformer 30 has the primary winding 31 mentioned above, and three windings provided on the secondary side. The three windings are a first secondary winding 32, a second secondary winding 33, and a third secondary winding 34. The primary winding 31 is connected to the first rectifying and smoothing circuit 10 through the switching circuit 20 and induces voltage in the secondary windings under PWM control performed by the PWM controller 22.

The switching power supply circuit 40 is configured of a rectifying diode 41, a smoothing capacitor 42, a diode 43, a transistor 44, a Zener diode 45, and resistors 46 and 47. The switching power supply circuit 40 is connected between the second secondary winding 33 of the high-frequency transformer 30 and the switching circuit 20 and supplies the power generated in the second secondary winding 33 to the switching circuit 20 for driving the PWM controller 22.

Next, the configuration for driving the PWM controller 22 will be described.

When the AC power supply 200 is connected to the charging device 1, the first rectifying and smoothing circuit 10 rectifies and smooths AC voltage supplied from the AC power supply 200. The resultant voltage is applied to the PWM controller 22 through the resistor 46, and current flows from the first rectifying and smoothing circuit 10 to ground via the resistor 46, the diode 43, the resistor 47 and Zener diode 45. At this time, the PWM controller 22 starts up and begins to perform PWM control since the voltage applied to the PWM controller 22 is equal to or greater than the minimum operating voltage of the PWM controller 22. When PWM control begins, a voltage is induced in the second secondary winding 33. The induced voltage is rectified and smoothed by the rectifying diode 41 and smoothing capacitor 42 and applied to the collector of the transistor 44. Further, current flows from the second secondary winding 33 to ground via the rectifying diode 41, the resistor 47, and Zener diode 45, and a voltage at a node between the resistor 47 and Zener diode 45 is maintained at a prescribed value which corresponds to the breakdown voltage of the Zener diode 45. At this time, current flows to the base of the transistor 44, switching the transistor 44 to an ON state. Once the transistor 44 is in an ON state, the induced voltage of the second secondary winding 33 serves as the driving power source for continuously driving the PWM controller 22.

The cutoff holding circuit 120 is configured of resistors 121A, 121B, 121C, 121D, and 121E; transistors 122A, 122B, and 122C; a Zener diode 123; and signal transmission units 124A and 124B. When the transistor 122C is in an ON state, the cutoff holding circuit 120 interrupts the supply of power from the second secondary winding 33 to the PWM controller 22, halting operations of the PWM controller 22 and placing the control power supply in a cutoff state. The control power supply is further maintained in the cutoff state by placing transistors 122A and 122B in an ON state.

The cathode of the Zener diode 123 is connected to the first rectifying and smoothing circuit 10 through the resistor 121A, while the anode is connected to ground. When the voltage outputted from the AC power supply 200 and applied to the cathode of the Zener diode 123 through the first rectifying and smoothing circuit 10 and resistor 121A is greater than the breakdown voltage of the Zener diode 123, the voltage at the cathode of the Zener diode 123 is maintained at a prescribed voltage.

The transistor 122A has an emitter connected to the first rectifying and smoothing circuit 10 through the resistor 121A, a collector connected to ground through the resistor 121D, and a base connected to the collector of the transistor 122B through the resistor 121B. The voltage regulated by the Zener diode 123 is applied to the emitter of the transistor 122A.

The transistor 122B has an emitter connected to ground, and a base connected to the collector of the transistor 122A through the resistor 121C. The transistor 122C has a collector connected to a node between the Zener diode 45 and resistor 47 of the switching power supply circuit 40, a base connected to the collector of the transistor 122A through the resistor 121A, and an emitter connected to ground.

The signal transmission unit 124A is configured of a phototransistor. The latter has a collector connected to the emitter of the transistor 122A and an emitter connected to the collector of the transistor 122A. The signal transmission unit 124A receives a cutoff signal for shutting down the PWM controller 22.

One terminal of the signal transmission unit 124B is connected to the base of the transistor 122C through the resistor 121E, and the other terminal is connected to ground. The signal transmission unit 124B receives a release signal for releasing the cutoff state of the control power supply for the PWM controller 22.

Next, the operations of the cutoff holding circuit 120 will be described.

When the charging device 1 is connected to the AC power supply 200, i.e., the input portion 10A of the first rectifying and smoothing circuit 10 is connected to the AC power supply 200, voltage regulated by the Zener diode 123 is applied to the emitter of the transistor 122A. However, none of the transistors in the cutoff holding circuit 120 turn on until the signal transmission unit 124A receives a cutoff signal. At this time, the cutoff holding circuit 120 is in its initial state.

Upon receiving a cutoff signal, the signal transmission unit 124A conducts electricity for a fixed period of time. Current flows to the base of the transistor 122B through the resistor 121C, switching the transistor 122B to an ON state. At the same time, current flows to the base of the transistor 122C through the resistor 121E, switching the transistor 122C to an ON state. By turning on the transistor 122B, the base of the transistor 122A is connected to ground through the resistor 121B and the transistor 122B, placing the transistor 122A in an ON state. When the transistor 122A is in an ON state, current flows to the respective bases of the transistors 122B and 122C, even after the signal transmission unit 124A is no longer conductive. The transistors 122A, 122B, and 122C are maintained in their ON states until the charging device 1 is disconnected from the AC power supply 200, that is, the input portion 10A of the first rectifying and smoothing circuit 10 is disconnected from the AC power supply 200 or the signal transmission unit 124B receives the release signal.

By placing the transistor 122C in an ON state, the node between the Zener diode 45 and resistor 47 of the switching power supply circuit 40 becomes connected to ground. Therefore, current no longer flows to the base of the transistor 44, placing the transistor 44 in an OFF state, and the voltage induced in the second secondary winding 33 is no longer applied to the PWM controller 22. Further, since the output from the AC power supply 200 is connected to ground through the resistor 46, diode 43, and resistor 47, only voltage divided by the resistors 46 and 47 is applied to the PWM controller 22. Since this divided voltage is lower than the minimum operating voltage of the PWM controller 22, the PWM controller 22 cannot operate on this divided voltage alone. Hence, turning the transistor 122C on and the transistor 44 off halts the operations of the PWM controller 22.

Upon receiving the release signal, the signal transmission unit 124B is rendered conductive for a fixed period of time. Consequently, the base of the transistor 122C is connected to ground through the resistor 121E. Similarly, the base of the transistor 122B is connected to ground through the resistor 121C. Since their bases are connected to ground, both transistors are turned off. When the transistor 122B is turned off, the base of the transistor 122A is disconnected from ground, placing the transistor 122A in an OFF state. Hence, all transistors in the cutoff holding circuit 120 are returned to their initial OFF state when the signal transmission unit 124B receives the release signal. Returning the cutoff holding circuit 120 to its initial state releases the control power supply from its cutoff state. Consequently, the transistor 44 of the switching power supply circuit 40 returns to its ON state, resuming driving the PWM controller 22.

All of the transistors 122A, 122B, and 122C are returned to an OFF state also when the charging device 1 is disconnected from the AC power supply 200, returning the cutoff holding circuit 120 to its initial state. Operations for driving the PWM controller 22 resume once the charging device 1 is reconnected to the AC power supply 200.

The second rectifying and smoothing circuit 50 is configured of a rectifying diode 51, and a smoothing capacitor 52. The second rectifying and smoothing circuit 50 rectifies and smooths power generated in the first secondary winding 32 of the high-frequency transformer 30 and outputs this power to the battery connection portion 90.

The constant-voltage power supply circuit 110 is configured of a rectifying diode 111, smoothing capacitors 112 and 113, and a three-terminal regulator 114. The constant-voltage power supply circuit 110 converts the power generated in the third secondary winding 34 to a desired voltage to produce a Vcc supply voltage for powering the control unit 80, relay circuit 70, detection units, and the like. The constant-voltage power supply circuit 110 is an example of a power supply circuit.

The charging current/voltage control circuit 60 is configured of a current/voltage negative feedback control circuit 61, and a current detection resistor 62. The charging current/voltage control circuit 60 detects the charging current using the current detection resistor 62, compares this charging current to a reference value inputted from the control unit 80, and outputs the difference to the switching circuit 20 through a signal transmission unit 63.

The relay circuit 70 is configured of a relay 71, a transistor 72, and a resistor 73. When a signal outputted from the control unit 80 flows to the base of the transistor 72 via the resistor 73, the transistor 72 is turned on and current from the Vcc supply voltage flows to ground, turning the relay 71 on. When the relay 71 is in an ON state, power can be supplied to the secondary battery for charging the same.

A first connection portion or the battery connection portion 90 is configured of a positive terminal 90a, and a negative terminal 90b. The positive terminal 90a is connected to the second rectifying and smoothing circuit 50 via the relay 71, and the negative terminal 90b is connected to the second rectifying and smoothing circuit 50 via the current detection resistor 62. The battery connection portion 90 can be connected to a battery pack that accommodates a secondary battery, i.e., a secondary battery is connectable to the battery connection portion 90. The charging device 1 can charge the secondary battery when the battery connection portion 90 is connected to the battery pack.

The release circuit 100 is configured of a capacitor 101; resistors 102, 103, and 104; a transistor 105; and a signal transmission unit 106. When the secondary battery is connected to the battery connection portion 90, the release circuit 100 outputs a release signal to the cutoff holding circuit 120 holding the control power supply in the cutoff state in order to release the control power supply from the cutoff state.

The base of the transistor 105 is connected to the positive terminal 90a of the battery connection portion 90 through the capacitor 101 and resistor 102. The collector of the transistor 105 is also connected to the positive terminal 90a through the resistor 104 and signal transmission unit 106, while the emitter is connected to ground.

When a secondary battery is connected to the battery connection portion 90, the positive terminal (not shown) of the secondary battery is connected to the capacitor 101 through the positive terminal 90a. Current flows from the positive terminal 90a to ground through the capacitor 101 and resistors 102 and 103 for only a fixed period of time during which charges are accumulated in the capacitor 101, i.e., current flows to the resistor 102. Thus, for this fixed period of time, current flows to the base of the transistor 105, placing the transistor 105 in an ON state. When the transistor 105 is in an ON state, the signal transmission unit 106 becomes conductive, transmitting a release signal to the cutoff holding circuit 120. Since the release circuit 100 is provided with a differentiating circuit configured of the capacitor 101 and resistor 102, the release circuit 100 can minimize the power consumption of the secondary battery for outputting the release signal.

The battery voltage detection circuit 130 is configured of transistors 131 and 132; and resistors 133, 134, 135, and 136. The transistor 131 has a collector connected to the positive terminal 90a of the battery connection portion 90, a base connected to the collector of the transistor 132 through the resistor 135, and an emitter connected to ground through the resistors 133 and 134. The base of the transistor 132 is connected to the Vcc supply voltage through the resistor 136, and the emitter is connected to ground.

When the Vcc supply voltage is supplied, current flows to the base of the transistor 132, switching the transistor 132 to an ON state. At this time, the base of the transistor 131 is connected to ground through the resistor 135. When the base of the transistor 131 is connected to ground, the transistor 131 switches to an ON state. As a result, the terminal voltage of the secondary battery is divided by the resistors 133 and 134 and the resulting divided voltage value is outputted to the control unit 80.

When the Vcc supply voltage is not supplied, the transistor 131 is no longer in an ON state. Accordingly, power from the secondary battery connected to the battery connection portion 90 is not consumed.

The battery type detection circuit 140 is provided for detecting a type of the secondary battery contained in the battery pack. The term “type” as used herein is intended to encompass materially distinguished battery, such as lithium-ion battery, and a number of battery cells contained in the battery pack. The battery pack contains a resistor having a specific resistance value identifying the type of the battery. The battery type detection circuit 140 is configured of a resistance value detection terminal 141, and a fixed resistor 142. When the battery pack is connected to the charging device 1, the fixed resistor 142 and the battery type identifying resistor are connected in series, and a Vcc supply voltage is applied to the serially-connected resistors. The Vcc supply voltage is divided by the two resistors and a voltage developed across the battery type identifying resistor appears at the terminal 141 and is outputted to the control unit 80. In this way, information about the type of the battery contained in the battery pack is given to the control unit 80.

The control unit 80 is configured of a microcomputer. The microcomputer primarily has a control value switching function port 81, a relay on/off port 82, a battery voltage detection and full-charge determination port 83, a battery detection and battery type determination port 84, and a cutoff signal output port 85. The control unit 80 is driven by a Vcc supply voltage supplied from the constant-voltage power supply circuit 110. The control unit 80 can control selected one of a charging voltage and a charging current using the PWM controller 22 and apply the controlled charging voltage or the controlled charging current to the secondary battery through the battery connection portion 90. The control unit 80 is an example of a charge controller.

The battery voltage detection and full-charge determination port 83 is connected to the battery voltage detection circuit 130 and receives a signal outputted by the battery voltage detection circuit 130.

The battery detection and battery type determination port 84 is connected to the battery type detection circuit 140 and receives a signal outputted by the battery type detection circuit 140.

The relay on/off port 82 is connected to the relay circuit 70. Based on signals inputted into the battery voltage detection and full-charge determination port 83 and battery detection and battery type determination port 84, the relay on/off port 82 outputs a signal to the relay circuit 70 for turning the relay circuit 70 on and off when starting and ending charging operations.

The control value switching function port 81 is connected to the charging current/voltage control circuit 60. Based on signals inputted into the battery voltage detection and full-charge determination port 83 and battery detection and battery type determination port 84, the control value switching function port 81 outputs a signal to the charging current/voltage control circuit 60 as a reference value.

The cutoff signal output port 85 is connected to the signal transmission circuit 150. Under prescribed conditions, the cutoff signal output port 85 outputs a cutoff signal to the signal transmission circuit 150 for interrupting the driving power to the PWM controller 22.

The signal transmission circuit 150 is configured of resistors 151 and 152, a transistor 153, and a signal transmission unit 154. The collector of the transistor 153 is connected to a Vcc supply voltage through the resistor 151 and signal transmission unit 154. The transistor 153 has a base connected to the cutoff signal output port 85 of the control unit 80 through the resistor 152, and an emitter connected to ground. When a cutoff signal is outputted from the control unit 80, the transistor 153 switches to an ON state, and the signal transmission unit 154 outputs a cutoff signal to the cutoff holding circuit 120.

Next, steps in the process for controlling charging operations of the charging device 1 will be described with reference to the flowcharts in FIGS. 2A and 2B.

In S301 of FIG. 2A, the charging device 1 is connected to the AC power supply 200 and AC power is inputted into the charging device 1. After the charging device 1 has been connected to the AC power supply 200, in S302 the PWM controller 22 initiates PWM control, producing a voltage in each secondary winding of the high-frequency transformer 30. In S303 the constant-voltage power supply circuit 110 regulates the voltage generated in the third secondary winding 34 to output a constant voltage to the control unit 80. As a result, the control unit 80 begins operating.

After the control unit 80 begins operating, in S304 the control unit 80 determines whether a secondary battery is connected to the battery connection portion 90. If the control unit 80 determines that a secondary battery is not connected, in S306 the control unit 80 determines whether this non-connected state has been continuous for a prescribed period of time. The control unit 80 repeats the determinations in S304 and S306 while the non-connected state has not been continuous for the prescribed period of time. If the control unit 80 determines in S306 that this non-connected state has continued for the prescribed period of time, in S312 of FIG. 2B the control unit 80 outputs a cutoff signal to the signal transmission circuit 150, and the signal transmission circuit 150 outputs a cutoff signal to the cutoff holding circuit 120 to halt operations of the PWM controller 22.

However, if the control unit 80 determines in S304 that a secondary battery is connected to the battery connection portion 90, in S305 the control unit 80 begins charging operations. Once charging has been initiated, in 5307 the control unit 80 determines whether the secondary battery has been disconnected. If the control unit 80 determines that the secondary battery has not been disconnected, in S308 the control unit 80 determines whether a full-charge condition has been met. If the control unit 80 determines in S308 that the full-charge condition has not been met, the control unit 80 returns to S307 and again determines whether the secondary battery has been disconnected. The control unit 80 determines whether the secondary battery has been disconnected based on whether a signal has been inputted from the battery type detection circuit 140 into the battery detection and battery type determination port 84. However, the control unit 80 may instead determine whether the secondary battery has been disconnected based on whether a signal has been inputted from the battery voltage detection circuit 130 into the battery voltage detection and full-charge determination port 83.

When the control unit 80 determines in S307 that the secondary battery has been disconnected or when the control unit 80 determines in S308 that the full-charge condition has been met, in S309 the control unit 80 outputs an OFF signal from the relay on/off port 82 to turn off the relay 71. Turning off the relay 71 interrupts the supply of power to the secondary battery, halting the charging operation for the secondary battery.

After charging has been halted in S309, in S310 the control unit 80 determines whether the battery was disconnected. If the control unit 80 determines that the secondary battery was disconnected, the control unit 80 returns to S304 and again determines whether a secondary battery has been connected to the battery connection portion 90.

However, if the control unit 80 determines in S310 that the secondary battery has not been disconnected, in S311 the control unit 80 determines whether a prescribed period of time has elapsed while the secondary battery has not been disconnected. If the control unit 80 determines in S311 that the prescribed period of time has not elapsed while the secondary battery has not been disconnected, the control unit 80 returns to S310 and again determines whether the secondary battery has been disconnected.

If the control unit 80 determines in S311 that the prescribed period of time has elapsed while the secondary battery has not been disconnected, in S312 the control unit 80 outputs a cutoff signal to the cutoff holding circuit 120 for halting operations of the PWM controller 22.

Once the operations of the PWM controller 22 have been halted, in S313 a voltage is no longer produced in all secondary windings, i.e., the first secondary winding 32, second secondary winding 33, and third secondary winding 34 of the high-frequency transformer 30. At this time, the control unit 80, detection units, and other components that require a Vcc supply voltage to operate are no longer driven and placed in power cutoff states because the Vcc supply voltage is not generated when voltage is not produced in the secondary windings of the high-frequency transformer 30.

As described above, the control unit 80 halts operations of the PWM controller 22 in the switching circuit 20 in S312 both when the prescribed period of time has elapsed while the secondary battery has not been connected (S306) and when the prescribed period of time has elapsed while the secondary battery remains connected after charging ends because the full-charge condition was met (S311). In other words, the control unit 80 halts the operations of the PWM controller 22 unless the secondary battery is being charged, and the control unit 80 is placed in the power cutoff state except when the secondary battery is being charged.

After power for driving the PWM controller 22 and the control unit 80 has been cut off, the charging device 1 is brought to a standby state. The state of the charging device 1 changes depending on whether a secondary battery has been connected to the battery connection portion 90 in S314. If a secondary battery remains connected to the battery connection portion 90 after charging has completed, in S316 the cutoff holding circuit 120 continues to hold the control power supply in a cutoff state so that power for driving the control unit 80 remains suspended. However, if power for driving the PWM controller 22 and control unit 80 was cut off because a secondary battery was not connected to the battery connection portion 90 continuously for the prescribed period of time (i.e., if the process advanced to S312 through S306), in S315 the release circuit 100 outputs a release signal to the cutoff holding circuit 120 when a secondary battery has been connected to the battery connection portion 90 in S314, releasing the control power supply from its cutoff state. After the cutoff state has been released, the process returns to S302.

Thus, the charging device 1 can reduce the amount of external power consumed while not performing charging operations by halting the operations of the PWM controller 22 and control unit 80. The charging device 1 can begin charging the secondary battery immediately only by connecting the secondary battery to the battery connection portion 90, because the release circuit 100 releases cutoff state of the control power supply held by the cutoff holding circuit 120 once the secondary battery is connected to the battery connection portion 90.

Further, only a slight amount of power is consumed when the charging device 1 is in the standby state for supplying external power to the cutoff holding circuit 120 in order to hold the control power supply in a cutoff state. This configuration greatly reduces the amount of power consumption compared to a configuration in which external power is supplied to the control unit 80 for controlling the standby state (S314).

In the charging device 1 mentioned above, supplying power from the constant-voltage power supply circuit 110 to the control unit 80 is halted to place the control unit 80 in the power cutoff state during a period of time from a time when the AC power supply 200 is connected to the input portion 10A of the first rectifying and smoothing circuit 10 to a time when the secondary battery is connected to the battery connection portion 90 and also during a period of time from a time when the secondary battery has become fully charged to a time when the secondary battery is disconnected from the battery connection portion 90. Hence, the charging device 1 can reduce the amount of power consumption before the start of charging and after the end of charging.

Further, the charging device 1 is provided with the release circuit 100 which acts on the control unit 80 to release from the power cutoff state and allows the constant-voltage power supply circuit 110 to supply the control unit 80 with power. In this way, releasing the control unit 80 from the power cutoff state is easily implemented with the provision of the release circuit 100.

Further, since the release circuit 100 becomes operable in response to connection of the secondary battery to the battery connection portion 90, the charging device 1 can begin charging the secondary battery automatically and immediately.

Further, since the control unit 80 is placed in the power cutoff state except when the secondary battery is being charged, the charging device 1 can suppress power consumption.

Further, the charging device 1 is provided with the cutoff holding circuit 120 configured to hold the power cutoff state until a prescribed condition is met. In other words, under the condition that the prescribed condition is not met, the Vcc supply voltage is not allowed to power the control unit 80. As such the charging device 1 can reduce the amount of power consumption.

Further, since the release circuit 100 releases the control unit 80 from the power cutoff state and allows the constant-voltage power supply circuit 110 to supply the control unit 80 with power when the prescribed condition is met, the charging device 1 can immediately begin charging the secondary battery when the prescribed condition is met. In this embodiment, the prescribed condition refers to the secondary battery having been connected to the battery connection portion 90. Therefore, when the prescribed condition is met, i.e., when the secondary battery is brought into connection to the charging device 1, the latter can immediately begin charging the secondary battery.

Further since the release circuit 100 releases the control unit 80 from the power cutoff state and allows the constant-voltage power supply circuit 110 to supply the control unit 80 with power in response to connection of the secondary battery to the battery connection portion 90, the control unit 80 is released from the power cutoff state automatically when the secondary battery is connected to the battery connection portion 90. Accordingly the charging device 1 can begin charging the secondary battery automatically and immediately.

Further, the charging device 1 is provided with the input portion 10A to which the AC power supply 200 is connectable, and the release circuit 100 releases the control unit 80 from the power cutoff state in response to disconnection of the AC power supply 200 from the input portion 10A. Hence, releasing the control unit 80 from the power cutoff state can be implemented only by disconnecting the AC power supply from the input portion 10A.

The release circuit 100 includes the differentiating circuit, and the release circuit 100 outputs the signal for releasing the control unit 80 from the power cutoff state. The signal is being outputted for the fixed period of time during which current flows to the differentiating circuit. As the signal is not outputted for an unlimited period of time, the charging device 1 can reduce the amount of power consumption.

Further, supplying power from the constant-voltage power supply circuit 110 to the control unit 80 starts from when the AC power supply 200 is connected to the input portion 10A and ends when the prescribed period of time has elapsed under a condition that the secondary battery has been disconnected from the battery connection portion 90. Hence, the charging device 1 can reduce the amount of power consumption after the secondary battery is disconnected from the battery connection portion 90, that is, the charging device 1 can reduce the amount of power consumption during the charging device 1 is in the standby state.

What is claimed is:

1. A charging device comprising:
a first connection portion to which a secondary battery is connectable;
a charge controller configured to control selected one of a charging voltage and a charging current and apply the controlled charging voltage or the controlled charging current to the secondary battery through the first connection portion;
a power supply circuit configured to supply the charge controller with power for driving the charge controller; and
a second connection portion to which an external power supply is connectable,
wherein supplying power from the power supply circuit to the charge controller is halted to place the charge controller in a power cutoff state during a period of time from a time when the external power supply is connected to the second connection portion to a time when the secondary battery is connected to the first connection portion and also during a period of time from a time when the secondary battery has become fully charged to a time when the secondary battery is disconnected from the first connection portion.

2. The charging device according to claim 1, further comprising a release circuit configured to release the charge controller from the power cutoff state and allow the power supply circuit to supply the charge controller with power.

3. The charging device according to claim 2, wherein the release circuit is configured to be operable in response to connection of the secondary battery to the first connection portion.

4. A charging device comprising:
a charge controller configured to control selected one of a charging voltage and a charging current and apply the controlled charging voltage or the controlled charging current to a secondary battery; and
a power supply circuit configured to supply the charge controller with power for driving the charge controller,
wherein supplying power from the power supply circuit to the charge controller is halted to place the charge controller in a power cutoff state except when the secondary battery is being charged.

5. The charging device according to claim 4, further comprising a cutoff holding circuit configured to hold the power cutoff state until a prescribed condition is met.

6. The charging device according to claim 5, further comprising a release circuit configured to release the charge controller from the power cutoff state and allow the power supply circuit to supply the charge controller with power when the prescribed condition is met.

7. The charging device according to claim 6, further comprising a battery connection portion to which the secondary battery is connectable,
wherein the prescribed condition includes connection of the secondary battery to the battery connection portion.

8. The charging device according to claim 6, further comprising a battery connection portion to which the secondary battery is connectable,
wherein the release circuit is configured to release the charge controller from the power cutoff state and allow the power supply circuit to supply the charge controller with power in response to connection of the secondary battery to the battery connection portion.

9. The charging device according to claim 6, further comprising an external power supply connection portion to which an external power supply is connectable,
wherein the release circuit is configured to release the charge controller from the power cutoff state in response to disconnection of the external power supply to the external power supply connection portion.

10. The charging device according to claim 6, wherein the release circuit includes a differentiating circuit, the release circuit being configured to output a signal for releasing the charge controller from the power cutoff state for a fixed period of time during which current flows to the differentiating circuit.

11. The charging device according to claim 4, further comprising a battery connection portion to which the secondary battery is connectable; and
an external power supply connection portion to which an external power supply is connectable,
wherein supplying power from the power supply circuit to the charge controller starts from when the external power supply is connected to the external power supply connection portion and ends when a prescribed period of time has elapsed under a condition that the secondary battery has been disconnected from the battery connection portion.
